(19) United States
(12) Patent Application Publication
(10) Pub. No.: US 2026/0232042 A1
(43) Pub. Date: Aug. 13, 2026

(54) SUSCEPTOR ELEMENT WITH MOUNTING REGION

(71) Applicant: Philip Morris Products S.A., Neuchatel (CH)

(72) Inventors: Farhang MOHSENI, Neuchâtel (CH); Patrick Charles SILVESTRINI, Neuchâtel (CH); Jean-Marc WIDMER, Lignières (CH)

(73) Assignee: Philip Morris Products S.A., Neuchatel (CH)

(21) Appl. No.: 19/156,545

(22) PCT Filed: Feb. 19, 2024
(86) PCT No.: PCT/EP2024/054189

§ 371 Date: Aug. 14, 2025

(30) Foreign Application Priority Data
Feb. 20, 2023 (EP) 23157635

(51) Int. Cl. A24F 40/70; A24F 40/465; H05B 6/10

(52) U.S. Cl. CPC A24F 40/70; A24F 40/465; H05B 6/10

(57) ABSTRACT

A method for manufacturing a susceptor element for an aerosol-generating system is provided, the method including: bonding a magnetic material to a non-magnetic material to form a susceptor sheet including: a heating region configured to heat an aerosol-forming substrate, and a mounting region configured to secure the susceptor element to a susceptor holder, the heating region including magnetic material and the mounting region including non-magnetic material, and the mounting region including a lower proportion by weight of magnetic material compared to the heating region.

The present disclosure relates to a susceptor element for an aerosol-generating system. In particular, the present disclosure relates to a susceptor element for an aerosol-generating system having an inductive heating assembly, and a method for manufacturing a susceptor element.

Aerosol-generating systems that employ inductive heating to heat an aerosol-forming substrate in order to generate an aerosol for user inhalation are generally known in the prior art. These systems typically comprise an aerosol-generating device including an inductive heating assembly, and a cartridge including an aerosol-forming substrate that is capable of releasing volatile compounds when heated that cool to form an inhalable aerosol. The cartridge is configured to be coupled to the aerosol-generating device. The inductive heating assembly comprises at least one inductor coil, which is configured to generate an alternating magnetic field in the cavity. A susceptor, either forming part of the cartridge or the device, is arranged in close proximity to the aerosol-forming substrate and within the alternating magnetic field. When the susceptor is penetrated by the alternating magnetic field, the susceptor is heated by at least one of Joule heating from induced eddy currents in the susceptor and hysteresis losses. The heated susceptor heats the aerosol-forming substrate causing volatile compounds to be released from the aerosol-forming substrate, which cool to form an inhalable aerosol.

One advantage of inductive heating systems is that the electrical components of the system can be isolated from the aerosol-forming substrate and any generated aerosol. Another advantage is that the construction of the cartridge can be simplified because there is no need to provide electrical connection with the device.

Several susceptor configurations have been described in the prior art. In many of these configurations, portions of the susceptor are in contact with other parts of the cartridge, such as the housing of the cartridge. This contact between the susceptor and other parts of the cartridge requires the other parts of the cartridge in contact with the susceptor to be configured to withstand the temperatures reached by the susceptor when it is heated. The contact between the susceptor and other parts of the cartridge may also give rise to conduction of heat away from the susceptor, reducing the efficiency of the system in heating the aerosol-forming substrate.

Some induction heated aerosol-generating systems utilise a susceptor element mounted within a plastic susceptor holder extending across a central air channel. However, as the susceptor is heated, there is heat loss from the susceptor to the susceptor holder resulting in reduced aerosol generation efficiency. Furthermore, the heat transfer from the susceptor element to the susceptor holder necessitates the use of heat resistant material or heat resistant coatings on the susceptor holder. This adds to the cost and complexity of the aerosol-generating system and its manufacturing processes.

It would be desirable to provide a susceptor element configured to more efficiently deliver heat to an aerosol-forming substrate. It would also be desirable to have a method for manufacturing such susceptor elements and cartridges for aerosol-generating systems in an effective and efficient manner.

According to a first aspect, the disclosure provides a method for manufacturing a susceptor element for an aerosol-generating system. The method may comprise bonding a magnetic material to a non-magnetic material to form a susceptor sheet. The susceptor sheet may comprise a heating region for heating an aerosol-forming substrate; and a mounting region for securing the susceptor element to a susceptor holder. The heating region may comprise magnetic material and the mounting region may comprise non-magnetic material.

According to a second aspect, the disclosure provides a method for manufacturing a susceptor element for an aerosol-generating system. The method comprises bonding a magnetic material to a non-magnetic material to form a susceptor element. The susceptor element comprises a heating region for heating an aerosol-forming substrate; and a mounting region for securing the susceptor element to a susceptor holder. The heating region comprises magnetic material and the mounting region comprises non-magnetic material.

Advantageously, providing a susceptor element with regions formed from different materials may enable different regions of the susceptor element to have different properties. This may enable the susceptor element to maximise heat losses in some regions, and minimise heat losses in other regions.

Advantageously, providing a susceptor element with a region comprising a non-magnetic material may reduce heating of the susceptor element at the region comprising the non-magnetic material, compared to other regions of the susceptor element that comprise magnetic material.

Advantageously, providing a susceptor element with a region comprising a lower proportion by weight of a magnetic material than other regions of the susceptor element may reduce heating of the susceptor element at the region with the lower proportion by weight of the magnetic material, compared to the other regions of the susceptor element comprising a higher proportion by weight of the magnetic material.

Advantageously, providing a susceptor element with at least one mounting region comprising a non-magnetic material, and a lower proportion by weight of a magnetic material compared to a heating region of the susceptor element, the mounting region when in contact with the susceptor holder may exhibit reduced heating from penetration with an alternating magnetic field compared the heating region, and may minimise heat losses from the susceptor element to the susceptor holder.

Providing a susceptor element with the above properties reduces the need for heat resistant components to mount the susceptor element to the susceptor holder. Therefore, the design and manufacture of the susceptor holder of such aerosol-generating systems may be simplified.

As used herein, the term “aerosol-generating device” relates to a device that interacts with a liquid aerosol-forming substrate to generate an aerosol.

As used herein, the terms “cartridge” and “aerosol-generating cartridge” relate to a component that interacts with a liquid aerosol-forming device to generate an aerosol. An aerosol-generating cartridge contains, or is configured to contain, a liquid aerosol-forming substrate.

As used herein, the term “liquid aerosol-forming substrate” relates to a liquid substrate capable of releasing volatile compounds that can form an aerosol. Such volatile compounds can be released by heating the aerosol-forming substrate.

As used herein, a “susceptor element” means an element that is heatable by penetration with an alternating magnetic field. A susceptor element is typically heatable by at least one of Joule heating through induction of eddy currents in the susceptor element or hysteresis losses.

As used herein, the term “electrically insulating” refers to a property in which current conduction is reduced or restricted. An electrically insulating component will conduct less current than an electrically conducting component.

As used herein, the term “thermally insulating” refers to a property in which heat transfer is reduced or restricted. A more thermally insulating component will transfer less heat, via conduction, convection or radiation, than a less thermally insulating component.

As used herein, the term “bonding” refers to the joining together of two materials to form a unitary structure comprising the two materials. Bonding of the two materials may comprise one of adhesion, compression, thermocompression, brazing, welding, chemical deposition or coating, or vapor deposition or coating and may be performed using any of the means known in the art.

The formed susceptor element comprises a heating region. The heating region is a region of the susceptor element that is configured to be heated to a temperature required to vaporise the aerosol-forming substrate upon penetration by a suitable alternating magnetic field. The heating region is configured to heat to a substantially higher temperature than the mounting region in the presence of an alternating magnetic field.

The heating region comprises a first material. The first material is a magnetic material heatable by penetration with an alternating magnetic field. The term “magnetic material” is used herein to describe a material which is able to interact with a magnetic field, including both paramagnetic and ferromagnetic materials. The first material may be any suitable magnetic material that is heatable by penetration with an alternating magnetic field. In some examples, the first material may comprise a ferromagnetic material. In other examples the first material may comprise a ferrimagnetic material. In some preferred examples, the first material comprises a ferritic stainless steel. Suitable ferritic stainless steels include AISI 400 series stainless steels, such as AISI type 409, 410, 420 and 430 stainless steels. In other examples, the first material may comprise one of AISI type 440, 444, stainless steel alloy 18SR, or Aluchrom.

In some preferred examples, the heating region may consist of the first material. However, in other examples, the heating region may comprise the first material and one or more other materials. Where the heating region comprises the first material and one or more other materials, the heating region may comprise any suitable proportion of the first material. For example, the heating region may comprise at least 10 per cent by weight of the first material, or at least 20 per cent by weight of the first material, or at least 30 per cent by weight of the first material, or at least 40 per cent by weight of the first material, or at least 50 per cent by weight of the first material, or at least 60 per cent by weight of the first material, or at least 70 per cent by weight of the first material, or at least 80 per cent by weight of the first material, or at least 90 per cent by weight of the first material.

The mounting region comprises a second material. The second material is a non-magnetic material. The term “non-magnetic material” is used herein to describe a material with a lower permeability than a magnetic material and does not undergo hysteresis losses under the presence of an alternating magnetic field. The second material may be any suitable non-magnetic material. In some examples, the second material is a non-magnetic metal. In some examples, the second material may comprise a non-ferromagnetic metal or alloy. For example, the second material may be a non-magnetic austenitic stainless steel. Suitable austenitic stainless steels include AISI 300 series stainless steels, such as AISI type 304, 309 and 316 stainless steels. The non-magnetic material may comprise an electrically conductive material. As used herein, an “electrically conductive” material means a material having a volume resistivity at 20 degrees Celsius (° C.) of less than about 1×10⁻⁵ ohm-metres (Ωm), typically between about 1×10⁻⁵ ohm-metres (Ωm) and about 1×10⁻⁹ ohm-metres (Ωm). Suitable electrically conductive materials include metals, alloys, electrically conductive ceramics and electrically conductive polymers. Suitable electrically conductive materials may include gold and platinum.

In some examples, the non-magnetic material may comprise an electrically insulating material. Advantageously an electrically insulative second material may help to minimise heat in the susceptor element at the mounting region, and consequently heat transfer to the susceptor holder. As used herein, an “electrically insulating” material means a material having a volume resistivity at 20 degrees Celsius (° C.) of greater than about 1×10⁶ ohm-metres (Ωm), typically between about 1×10⁹ ohm-metres (Ωm) and about 1×10²¹ ohm-metres (Ωm). Suitable electrically insulating materials include glasses, plastics and certain ceramic materials. In such examples, the mounting region may also comprise an electrically conductive material capable of inducing eddy currents in the presence of an alternating magnetic field. Therefore, while the mounting region may still generate heat in the presence of an alternating magnetic field, less heat may be generated compared to that in the heating region.

In some examples, the second material comprises a thermally insulative material. Advantageously a thermally insulative second material may help to minimise heat transfer from the susceptor element to the susceptor holder. As used herein, the term “thermally insulative” refers to a material having a bulk thermal conductivity of less than about 5 Watts per metre Kelvin (mW/(m K)) at 23° C. and a relative humidity of 50% as measured using the modified transient plane source (MTPS) method.

In some examples, the second material may be a hydrophilic material. In some examples, the second material may be an oleophilic material. Advantageously, providing a hydrophilic second material or an oleophilic second material may encourage the transport of the aerosol-forming substrate through the susceptor element.

In some examples, the second material may comprise a cellulosic material. For example, the second material may comprise rayon.

In some preferred examples, the mounting region consists of the second material. However, in other examples, the mounting region comprises the second material and one or more other materials. Where the mounting region comprises the second material and one or more other materials, the mounting region may comprise any suitable proportion of the second material. For example, the mounting region of the susceptor element may comprise: at least 10 per cent by weight of the second material, or at least 20 per cent by weight of the second material, or at least 30 per cent by weight of the second material, or at least 40 per cent by weight of the second material, or at least 50 per cent by weight of the second material, or at least 60 per cent by weight of the second material, or at least 70 per cent by weight of the second material, or at least 80 per cent by weight of the second material, or at least 90 per cent by weight of the second material.

The mounting region may comprise the first material. However, the mounting region comprises a lower proportion of the first material than the heating region. The proportion by weight of the first material in the heating region is greater than the proportion by weight of the first material in the mounting region. For example: the heating region of the susceptor element may comprise at least 90 percent by weight of the first material, and the mounting region of the susceptor element may comprise less than 10 percent by weight of the first material, or the heating region of the susceptor element may comprise at least 80 percent by weight of the first material, and the mounting region of the susceptor element may comprise less than 20 percent by weight of the first material, or the heating region of the susceptor element may comprise at least 70 percent by weight of the first material, and the mounting region of the susceptor element may comprise less than 30 percent by weight of the first material, or the heating region of the susceptor element may comprise at least 60 percent by weight of the first material, and the mounting region of the susceptor element may comprise less than 40 percent by weight of the first material, or the heating region of the susceptor element may comprise at least 50 percent by weight of the first material, and the mounting region of the susceptor element may comprise less than 50 percent by weight of the first material.

The mounting region may comprise: 90 per cent or less by weight of the first material, or 80 per cent or less by weight of the first material, or 70 per cent or less by weight of the first material, or 60 per cent or less by weight of the first material, or 50 per cent or less by weight of the first material, or 40 per cent or less by weight of the first material, or 30 per cent or less by weight of the first material, or 20 per cent or less by weight of the first material, or 10 per cent or less by weight of the first material.

The mounting region may comprise: at least 10 percent by weight of the second material, and less than 90 percent by weight of the first material, or at least 20 percent by weight of the second material, and less than 80 percent by weight of the first material, or at least 30 percent by weight of the second material, and less than 70 percent by weight of the first material, or at least 40 percent by weight of the second material, and less than 60 percent by weight of the first material, or at least 50 percent by weight of the second material, and less than 50 percent by weight of the first material, or at least 60 percent by weight of the second material, and less than 40 percent by weight of the first material, or at least 70 percent by weight of the second material, and less than 30 percent by weight of the first material, or at least 80 percent by weight of the second material, and less than 20 percent by weight of the first material, or at least 90 percent by weight of the second material, and less than 10 percent by weight of the first material.

The heating region may comprise the second material. For example, the heating region may comprise: 90 per cent or less by weight of the second material, or 80 per cent or less by weight of the second material, or 70 per cent or less by weight of the second material, or 60 per cent or less by weight of the second material, or 50 per cent or less by weight of the second material, or 40 per cent or less by weight of the second material, or 30 per cent or less by weight of the second material, or 20 per cent or less by weight of the second material, or 10 per cent or less by weight of the second material.

The heating region may comprise: at least 10 percent by weight of the first material, and less than 90 percent by weight of the second material, or at least 20 percent by weight of the first material, and less than 80 percent by weight of the second material, or at least 30 percent by weight of the first material, and less than 70 percent by weight of the second material, or at least 40 percent by weight of the first material, and less than 60 percent by weight of the second material, or at least 50 percent by weight of the first material, and less than 50 percent by weight of the second material, or at least 60 percent by weight of the first material, and less than 40 percent by weight of the second material, or at least 70 percent by weight of the first material, and less than 30 percent by weight of the second material, or at least 80 percent by weight of the first material, and less than 20 percent by weight of the second material, or at least 90 percent by weight of the first material, and less than 10 percent by weight of the second material.

The heating region may comprise any suitable proportion of the susceptor element. For example, the heating region may comprise at least 90 per cent of the surface area of the susceptor element, at least 80 per cent of the surface area of the susceptor element, or at least 70 per cent of the surface area of the susceptor element. The heating region may have any suitable size and shape for heating aerosol-forming substrate at the required rate to generate the desired amount of inhalable aerosol.

The mounting region may comprise any suitable proportion of the susceptor element. Typically the mounting region comprises a smaller proportion of the susceptor element than the heating region. For example, the mounting region may comprise 10 per cent or less of the surface area of the susceptor element, or 20 percent or less of the surface area of the susceptor element, or 30 percent or less of the surface area of the susceptor element. The mounting region may have any suitable size and shape for providing a robust connection between the susceptor element and the susceptor holder.

In some examples, the mounting region is located adjacent a periphery of the heating region, wherein the heating region has a length and a width, and the mounting region has a length and a width. Preferably, the length of the mounting region is less than the length of the heating region. In some examples, the length of the mounting region may be no more than half of the length of the heating region. In some examples, the length of the mounting region may be no more than a quarter of the length of the heating region.

The mounting region of the susceptor element may be arranged at any suitable position relative to the heating region of the susceptor element. In some preferred examples, the mounting region of the susceptor element is at a periphery of the susceptor element. For example, the mounting region may be located at one side of the susceptor element.

In some examples, the magnetic material may be bonded with the non-magnetic material in a way that creates multiple mounting regions. For example, magnetic material may be bonded around a central portion of the non-magnetic material to create a central heating region between two mounting regions positioned at either end of the heating region. In other examples, multiple non-magnetic materials may be bonded with different regions of the magnetic material to form multiple mounting regions extending from a heating region. In some examples, two, three, four, five, or six non-magnetic materials may be bonded to the magnetic material to create a respective two, three, four, five, or six mounting regions. Advantageously, providing the susceptor element with a plurality of mounting regions may enable the susceptor holder to provide more robust support to the susceptor element compared to a susceptor element having a single mounting region.

In some examples, a first non-magnetic material is bonded to one side of the magnetic material, and a second non-magnetic material is bonded to the same side of the magnetic material to create two mounting regions on the same side of the susceptor element. In some of these examples, the first mounting region is positioned at a first end of the susceptor element, and the second mounting region is positioned at a second end of the susceptor element, opposite the first end.

In some examples, a first non-magnetic material is bonded to one side of the magnetic material, and a second non-magnetic material is bonded to a second side of the magnetic material, opposite to the first side to create mounting regions on opposite sides of the susceptor element.

In some of these examples, the heating region has a length, and the first mounting region and the second mounting region are positioned at the same position along the length of the heating region. In some of these examples, the first mounting region and the second mounting region are positioned at one end of the susceptor element. In some of these examples, the heating region has a length, and the first mounting region and the second mounting region are positioned centrally along the length of the heating region. In some of these examples, the heating region has a length, and the first mounting region and the second mounting region are positioned at different positions along the length of the heating region. In some of these examples, the first mounting region is positioned at a first end of the susceptor element, and the second mounting region is positioned at a second end of the susceptor element, opposite to the first end.

The magnetic material may be bonded to the non-magnetic material to form a susceptor element which is substantially planar. The formed susceptor element may be planar. In other words, the susceptor element may generally extend in a plane. The formed susceptor element may be flat. The formed susceptor element may be thin. In other words, the formed susceptor element may have a thickness dimension that is substantially smaller than the width and length dimensions of the susceptor element. The thickness of the formed susceptor element is advantageously between 2 and 10 times the skin depth of the material of the susceptor element at the frequency of operation of the system.

In some examples, the bonding of the magnetic material with the non-magnetic material may comprise adhesion using one or more adhesives. The one or more adhesives may be resistant to operational temperatures of an aerosol-generating system. In some cases, the one or more adhesives may be resistant to temperature up to 350 degrees centigrade.

In some examples, the method may comprise cutting the bonded susceptor element into a plurality of susceptor elements, each comprising a heating region and a mounting region. Advantageously, such methods may use a single bonding process to efficiently produce multiple susceptor elements.

In an example, the method may comprise bonding a first plurality of strips of magnetic material at spaced intervals across a strip of non-magnetic material. The susceptor sheet may then be cut to form a plurality of susceptor elements. Advantageously, a plurality of susceptor elements may be efficiently formed from a single strip of non-magnetic material.

In some examples, the plurality of strips of magnetic material may be provided across the width of the strip of non-magnetic material. The method may further comprise compressing the strips of magnetic material into the strip of non-magnetic material to form the susceptor sheet and cutting the susceptor sheet widthways to produce a plurality of susceptor elements, each having a heating region between two mounting regions. In some examples, the compression may be performed using one or more rollers.

In some examples, a second plurality of strips of magnetic material may be bonded at spaced intervals across the strip of non-magnetic material on an opposite side to the first plurality of magnetic strips. The first plurality of strips may substantially align with the second plurality of strips.

In some examples, the method may comprise bonding a first plurality of strips of non-magnetic material at spaced intervals at an edge region along a length of a strip of magnetic material to form a susceptor sheet having a non-magnetic region along an edge of the length of the susceptor sheet. The method may then comprise cutting the susceptor sheet widthways into a plurality of susceptor elements, each susceptor element having a mounting region at an end of a heating region.

In some examples, the method may comprise bonding a second plurality of strips of non-magnetic material at spaced intervals at an opposing edge region along the length of the strip of magnetic material. The first plurality of strips may substantially align with the second plurality of strips. The method may then comprise cutting the susceptor sheet widthways into a plurality of susceptor elements, each susceptor element having a mounting region at opposite ends of a heating region.

In some examples, the non-magnetic material may be bonded to the magnetic material by deposition onto the surface of the magnetic material. In some examples, a non-magnetic coating or layer may be formed on the surface of one or more regions of the magnetic material to form a respective one or more mounting regions. In some examples, the non-magnetic coating or layer may be formed on the magnetic material by one of chemical deposition, vapor deposition, or dip coating. One or more regions of the magnetic material may be shielded during the deposition of non-magnetic material in order to preserve heating regions on the susceptor element.

In some examples, the method may comprise perforating the heating region of the susceptor element to create a fluid permeable heating region.

In some examples, the method may comprise perforating the mounting region of the susceptor element to create a fluid permeable mounting region.

As used herein a “fluid permeable” element means an element that allows liquid or gas to permeate through it. The susceptor element may have a plurality of openings formed in it to allow fluid to permeate through it. In particular, the susceptor element may allow the aerosol-forming substrate, in either gaseous phase or both gaseous and liquid phase, to permeate through it.

According to a third aspect, the disclosure provides a susceptor element manufactured according to a method of any of the examples described above.

According to a fourth aspect, the disclosure provides a cartridge for an aerosol-generating system, comprising a susceptor holder mounting a susceptor element according to the third aspect across an air channel. The susceptor element is mounted to the susceptor holder at the mounting region. At least a portion of the mounting region extends across the air channel.

According to a fifth aspect, the disclosure provides an aerosol-generating system comprising the cartridge according to the fourth aspect.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: A method for manufacturing a susceptor element for an aerosol-generating system, the method comprising:
bonding a magnetic material to a non-magnetic material to form a susceptor sheet comprising:
   a heating region for heating an aerosol-forming substrate; and
   a mounting region for securing the susceptor element to a susceptor holder, wherein the heating region comprises magnetic material and the mounting region comprises non-magnetic material.

Example Ex2: The method according to Ex1, wherein the non-magnetic material comprises an electrically insulating material.

Example Ex3: The method according to any preceding Ex, wherein the non-magnetic material comprises a thermally insulating material.

Example Ex4: The method according to any preceding Ex, wherein the bonding comprises adhesion.

Example Ex5: The method according to any one of Ex1-Ex3, wherein the bonding comprises thermocompression.

Example Ex6: The method according to any one of Ex1-Ex3, wherein the bonding comprises one of brazing or welding.

Example Ex7: The method according to any one of Ex1-Ex3, wherein the bonding comprises compression.

Example Ex8: The method according to any one of Ex1-Ex3, comprising:
bonding a first plurality of strips of magnetic material at spaced intervals across a strip of non-magnetic material; and
cutting the susceptor sheet to form a plurality of susceptor elements.

Example Ex9: The method according to Ex8, comprising:
providing the plurality of strips of magnetic material at spaced intervals across the width of the strip of non-magnetic material, and
compressing the strips of magnetic material into the strip of non-magnetic material to form the susceptor sheet.

Example Ex10: The method according to Ex9, further comprising compressing the strips of magnetic material into the strip of non-magnetic material using one or more rollers. Example Ex11: The method according to any of Ex8 to Ex10, further comprising:
bonding a second plurality of strips of magnetic material at spaced intervals across the strip of non-magnetic material opposite the first plurality of magnetic strips, wherein the first plurality of strips substantially align with the second plurality of strips; and
cutting the susceptor sheet widthways to form a plurality of susceptor elements, each susceptor element having a heating region separating two opposing mounting regions.

Example Ex12: The method according to any of Ex1 to Ex3, wherein the bonding comprises depositing the non-magnetic material on a surface of a sheet of magnetic material at a mounting region.

Example Ex13: The method according to Ex12, wherein the depositing comprises chemical vapor deposition.

Example Ex14: The method according to Ex12, wherein the depositing comprises physical vapor deposition.

Example Ex15: The method according to Ex12, wherein the depositing comprises dip-coating.

Example Ex16: The method according to any of Ex1 to Ex3, and Ex12 to Ex15, comprising:
bonding a first plurality of strips of non-magnetic material at spaced intervals at an edge region along a length of a strip of magnetic material; and
cutting the susceptor sheet widthways into a plurality of susceptor elements.

Example Ex17: The method according to Ex16, comprising:
bonding a second plurality of strips of non-magnetic material at spaced intervals at an opposing edge region along the length of the strip of magnetic material, wherein the first plurality of strips substantially align with the second plurality of strips.

Example Ex18: The method according to any preceding Ex, further comprising perforating the heating region of the susceptor element.

Example Ex19: The method according to any preceding Ex, further comprising perforating the mounting region of the susceptor element.

Example Ex20: The method according to any preceding Ex, wherein the magnetic material comprises stainless steel 430.

Example Ex21: The method according to any preceding Ex, wherein the non-magnetic material comprises stainless steel 304.

Example Ex22: A susceptor element manufactured using a method according to any preceding Ex.

Example Ex23: A cartridge for an aerosol-generating system, comprising a susceptor holder mounting a susceptor element according to Ex22 across an air channel.

Example Ex24: A cartridge according to Ex23, wherein the susceptor element is mounted to the susceptor holder at the mounting region.

Example Ex25: The cartridge according to any of Ex23 or Ex24, wherein at least a portion of the mounting region extends across the air channel.

Example Ex26: An aerosol-generating system comprising a cartridge according to any of Ex23 to Ex25.

Examples will now be further described with reference to the accompanying Figures, wherein:

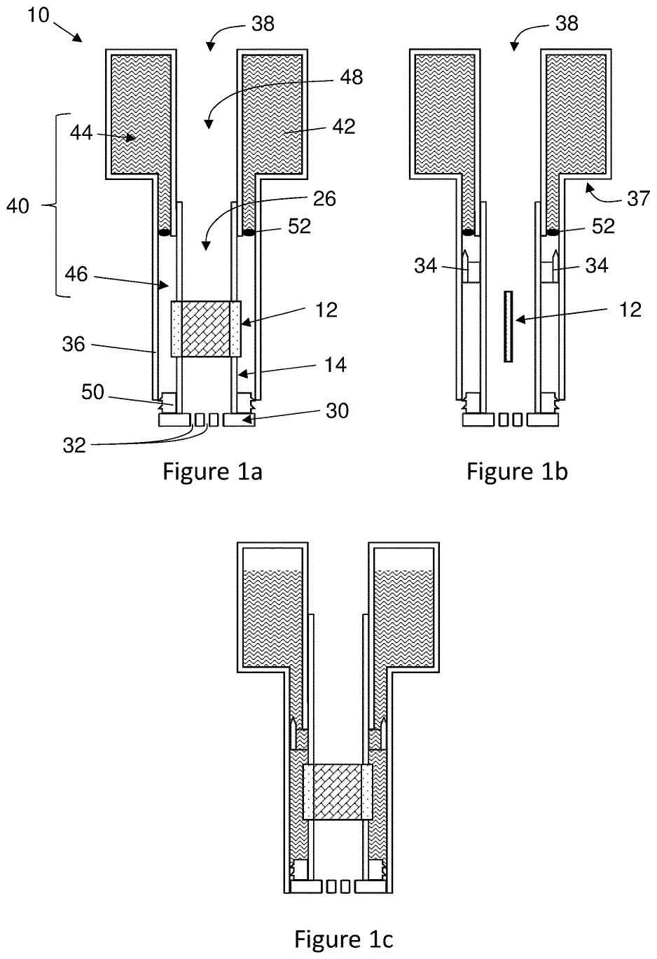

FIG. 1a shows a schematic illustration of a cartridge for an aerosol-generating system in accordance with an example of the present disclosure, wherein the cartridge is in a storage configuration;

FIG. 1b shows a schematic illustration of the cartridge of FIG. 1a rotated by 90 degrees about a central longitudinal axis of the cartridge;

FIG. 1c shows a schematic illustration of the cartridge of FIG. 1a, wherein the cartridge is in a use configuration;

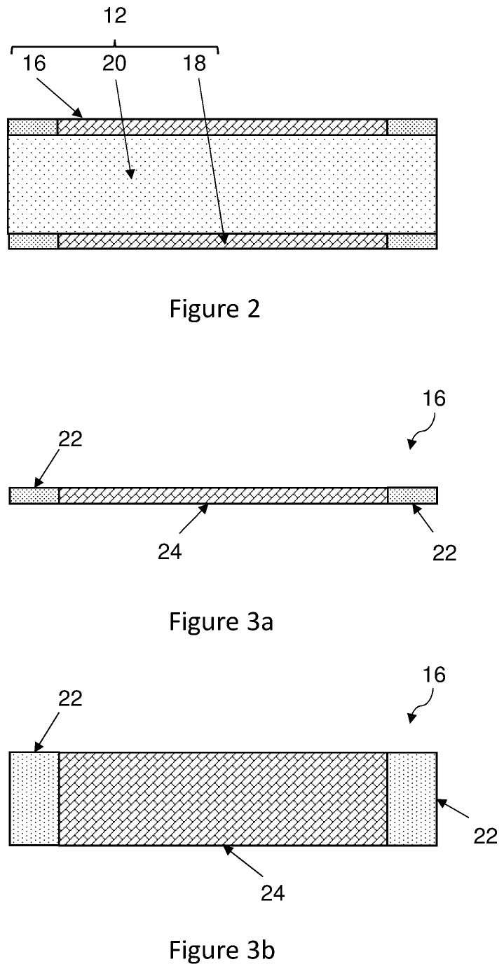

FIG. 2 shows a side view of a susceptor assembly of the cartridge of FIGS. 1a and 1b;

FIG. 3a shows a side view of a susceptor element of the susceptor assembly of FIG. 2 according to an example of the disclosure;

FIG. 3b shows a plan view of a susceptor element of FIG. 3;

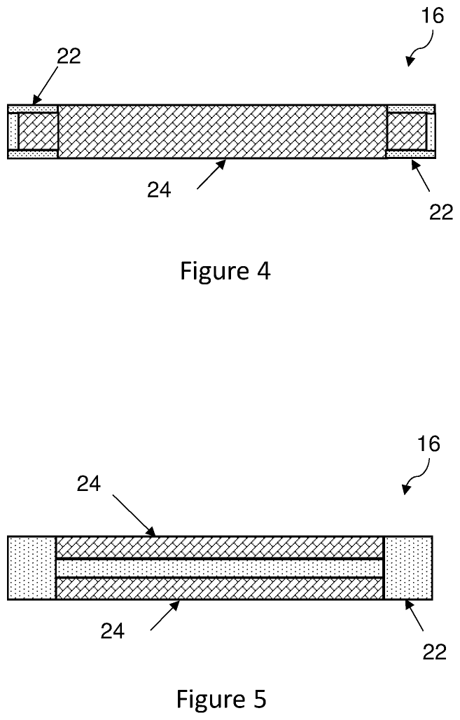

FIG. 4 shows a side view of a susceptor element of the susceptor assembly of FIG. 2 according to an example of the disclosure;

FIG. 5 shows a side view of a susceptor element of the susceptor assembly of FIG. 2 according to an example of the disclosure;

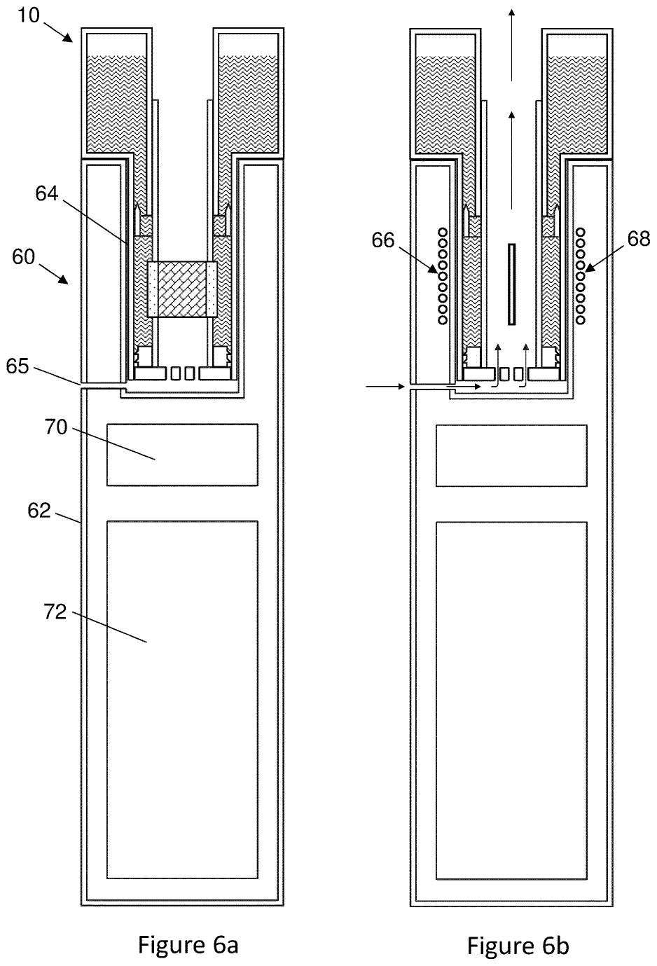

FIG. 6a shows a schematic illustration of an aerosol-generating system according to an example of the present disclosure, the aerosol-generating system comprising the cartridge of FIGS. 1a and 1b received in an aerosol-generating device;

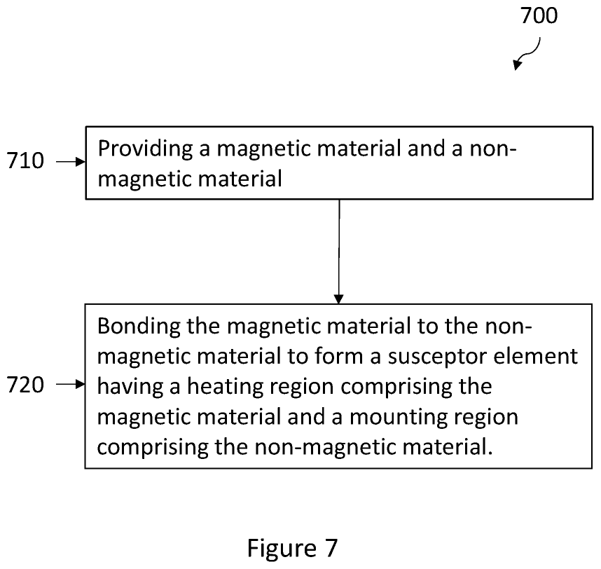

FIG. 6b shows a schematic illustration of the aerosol-generating system of FIG. 6a rotated by 90 degrees about a central longitudinal axis of the aerosol-generating system;
FIG. 7 shows a method for manufacturing a susceptor element for an aerosol-generating system according to an example of the disclosure.

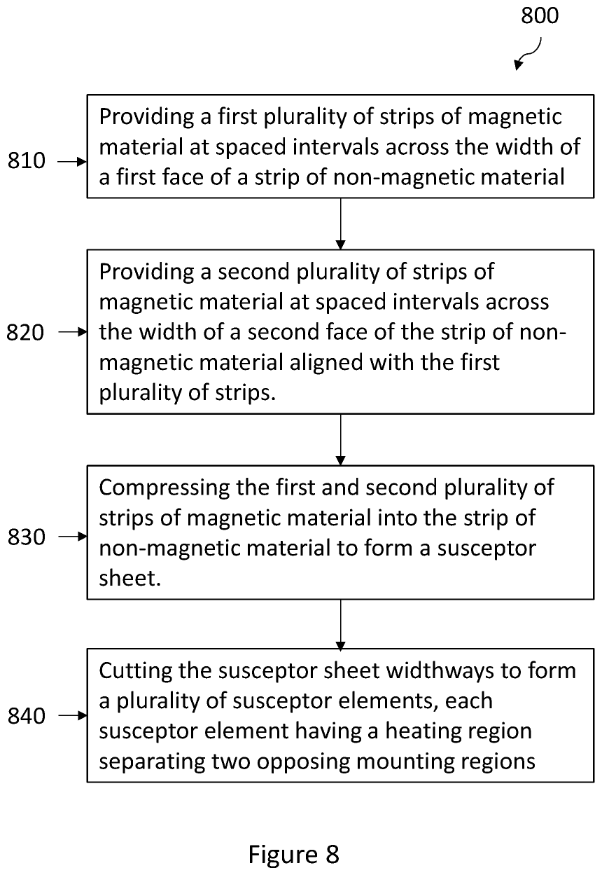

FIG. 8 shows a method for manufacturing a susceptor element for an aerosol-generating system according to an example of the disclosure.

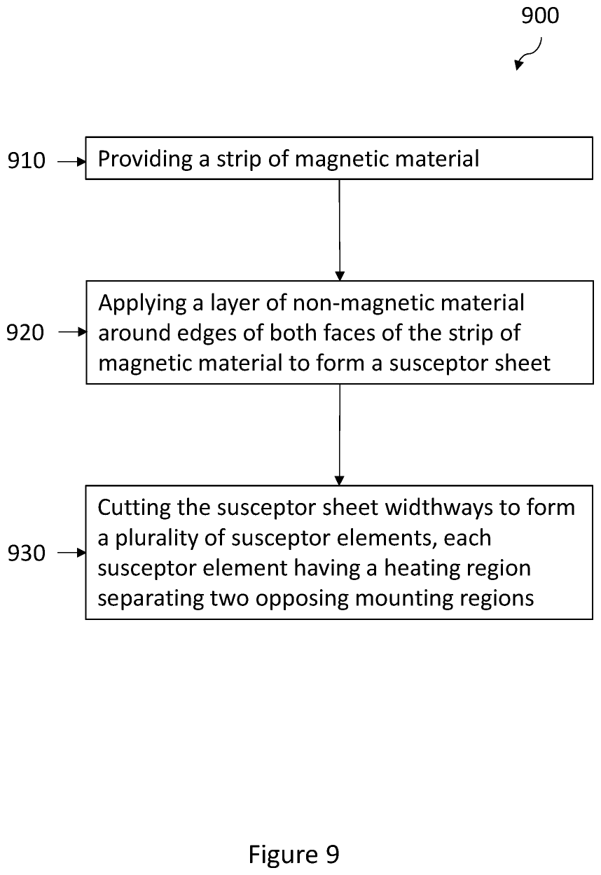

FIG. 9 shows a method for manufacturing a susceptor element for an aerosol-generating system according to an example of the disclosure.

The above and other features and advantages of example embodiments will become more apparent by describing in detail, example embodiments with reference to the attached drawings. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

Spatially relative terms (for example, “below”) may be used herein for ease of description to describe one element or feature's relationship to another element or feature as illustrated in the figures. It should be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Therefore, the term “below” may encompass both an orientation of above and below. The device may be otherwise oriented (rotated 90 degrees or at other orientations) and the spatially relative descriptors used herein interpreted accordingly.

It should be understood that when an element or layer is referred to as being “disposed on”, another element or layer, it may be directly on, connected to, coupled to, or covering the other element or layer, or intervening elements or layers may be present. In contrast, when an element is referred to as being “directly disposed on” another element or layer, there are no intervening elements or layers present.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations or elements, but do not preclude the presence or addition of one or more other features, integers, steps, operations, elements or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques or tolerances, are to be expected. Therefore, example embodiments should not be construed as limited to the shapes of regions illustrated herein but are to include deviations in shapes that result, for example, from manufacturing. Therefore, the regions illustrated in the figures are schematic in nature and their shapes are not intended to illustrate the actual shape of a region of a device and are not intended to limit the scope of example embodiments. The same reference numerals represent the same elements throughout the drawings. The accompanying drawings are not to be considered as drawn to scale unless explicitly noted. It will be appreciated that the figures in the application are schematic, and that some features have been omitted for the sake of clarity.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The accompanying drawings are intended to depict example embodiments and should not be interpreted to limit the intended scope of the claims.

FIGS. 1a, 1b and 1c show schematic illustrations of a cartridge 10 for an aerosol generating device according to an example of the present disclosure.

The cartridge 10 comprises a susceptor assembly 12 mounted in a susceptor holder 14. The susceptor assembly 12 is shown in more detail in FIG. 2. The susceptor assembly 12 is planar, and thin, having a thickness dimension that is substantially smaller than a length dimension and a width dimension. The susceptor assembly 12 is shaped in the form of a rectangular strip, and comprises three layers, a first susceptor element 16, a second susceptor element 18, and a wicking element 20 arranged between the first and second susceptor elements 16, 18. Each of the first susceptor element 16, the second susceptor element 18, and the wicking element 20 generally forms the shape of a rectangular strip, and each element has the same length and width dimensions. The first and second susceptor elements 16, 18 are substantially identical, and comprise a sintered mesh formed from ferritic stainless steel filaments and austenitic stainless steel filaments, as described in more detail below. The wicking element 20 comprises a porous body of rayon filaments. The wicking element 20 is configured to convey liquid from the outer, exposed surfaces of the wicking element 20 to the first and second susceptor elements 16, 18.

As illustrated in FIGS. 3a and 3b, each of the first and second susceptor elements 16, 18 comprises a pair of mounting regions 22 and a heating region 24. The heating region 24 is a substantially rectangular region located centrally on the susceptor elements 16, 18. The pair of mounting regions 22 are also substantially rectangular regions located at the periphery of the heating region 24, at opposite sides of the heating region 24.

Each of the pair of mounting regions 22 has a smaller surface area than the heating region 24. The length of each of the mounting regions 22 is less than the length of the heating region 24, and the width of each of the mounting regions 22 is equal to the width of the heating region 24.

The heating region 24 is configured to be heatable by penetration with an alternating magnetic field, for vaporising an aerosol-forming substrate. The pair of mounting regions 22 are configured to contact the susceptor holder 14, such that the susceptor holder 14 can support the susceptor assembly 12 in position in the cartridge 10. The pair of mounting regions 22 are configured to minimise heat transfer from the susceptor assembly 12 to the susceptor holder 14.

Providing the first and second susceptor elements 16, 18 with mounting regions 22 having a reduced cross-section compared to the heating region 24, and at least partially comprising the mounting regions 22 from a non-magnetic material, helps to reduce heating of the mounting regions 22 when the susceptor elements are penetrated by an alternating magnetic field. Such a configuration also helps to reduce heat transfer from the susceptor assembly 12 to the susceptor holder 14.

FIGS. 4 and 5 each illustrate a susceptor element according to alternative examples of the disclosure. In FIG. 4, mounting regions 22 comprise a non-magnetic material on their outer surface, thereby reducing the heat transfer from the susceptor assembly 12 to the susceptor holder 14. FIG. 5 illustrates an embodiment in which the magnetic material is provided on a central portion of a non-magnetic material in order to form a heating region 24 between two mounting regions 22 at each end of the non-magnetic material.

The heating region 24 comprises stainless steel 430. The pair of mounting regions 22 comprise stainless steel 304. Accordingly, the heating region 24 is comprised of a magnetic material, and the pair of mounting regions 22 are in part comprised of a magnetic material, and in part comprised of a non-magnetic material. The proportion by weight of the stainless steel 430 in the heating region 24 is greater than the proportion by weight of the stainless steel 430 in each of the pair of mounting regions 22.

It will be appreciated that in other embodiments the heating region 24 and the pair of mounting regions 22 may be formed from other combinations of magnetic and non-magnetic materials. In some embodiments, the heating region 24 is in part comprised of a magnetic material, and in part comprised of a non-magnetic material, and the pair of mounting regions 22 consist of a non-magnetic material.

Referring back to the cartridge 10 of FIGS. 1a-c, the susceptor holder 14 comprises a tubular body formed from a mouldable plastic material, such as polypropylene. The tubular body of the susceptor holder 14 comprises a side wall defining an internal passage 26, having open ends. A pair of openings extend through the side wall, at opposite sides of the tubular susceptor holder 14. The openings are arranged centrally along the length of the susceptor holder 14.

The susceptor assembly 12 is arranged inside the internal passage 26 of the tubular susceptor holder 14, and extends in a plane parallel to a central longitudinal axis of the susceptor holder 14. The heating region 24 of the first and second susceptor elements 16, 18 is arranged entirely within the internal passage 26 of the susceptor holder 14, and each of the mounting regions 22 extends through one of the openings in the side wall of the susceptor holder 14. The openings in the side wall of the susceptor holder 14 are sized to accommodate the susceptor assembly 12 with a friction fit, such that the susceptor assembly is secured in the susceptor holder 14. The friction fit between the susceptor assembly 12 and the susceptor holder 14 results in the mounting regions 22 directly contacting the susceptor holder 14 at the openings. The susceptor assembly 12 and the susceptor holder 14 are secured together such that movement of the susceptor holder 14 also moves the susceptor assembly 12.

It will be appreciated that the susceptor assembly 12 and the susceptor holder 14 may be secured together by other means. For example, in some embodiments the susceptor assembly 12 is secured to the susceptor holder 14 by an adhesive at the mounting regions 22 of the susceptor assembly 12, such that the mounting regions 22 indirectly contact the susceptor holder 14.

The susceptor holder 14 comprises a base 30 that partially closes one end of the internal passage 26. The base 30 comprises a plurality of air inlets 32 that enable air to be drawn into the internal passage 26 through the partially closed end.

The susceptor holder 14 further comprises a pair of piercing elements 34 extending from an outer surface of the side wall, towards the open end of the susceptor holder 14 opposite the end partially closed by the base 30. The openings in the sidewall of the susceptor holder 14 are arranged between the piercing elements 34 around the circumference of the side wall, such that the piercing elements 34 are offset from the openings around the circumference of the side wall of the tubular susceptor by about 90 degrees. Each of the piercing elements 34 comprises spike facing in the direction of the open end of the susceptor holder 14.

The cartridge 10 further comprises an outer housing 36 formed from a mouldable plastics material, such as polypropylene. The outer housing 36 generally forms a hollow cylinder, defining an internal space in which the susceptor assembly 12 and the susceptor holder 14 are contained.

The outer housing 36 forms a first portion of the cartridge 10, and the susceptor assembly 12 and the susceptor holder 14 form a second portion of the cartridge 10. The second portion of the cartridge is slidable relative to the first portion of the cartridge between a storage configuration, as shown in FIGS. 1a and 1b, and a use configuration, as shown in FIG. 1c.

The cartridge 10 has a mouth end, and a connection end, opposite the mouth end. The outer housing 36 defines a mouth end opening 38 at the mouth end of the cartridge 10. The connection end is configured for connection of the cartridge 10 to an aerosol-generating device, as described in detail below. The susceptor assembly 12 and the susceptor holder 14 are located towards the connection end of the cartridge 10. The external width of the outer housing 36 is greater at the mouth end of the cartridge 10 than at the connection end, which are joined by a shoulder 37. This enables the connection end of the cartridge to be received in a cavity of an aerosol-generating device, with the shoulder 37 locating the cartridge in the correct position in the device. This also enables the mouth end of the cartridge 10 to remain outside of the aerosol-generating device, with the mouth end conforming to the external shape of the aerosol-generating device.

A liquid reservoir 40 is defined in the cartridge for holding a liquid aerosol-forming substrate 42. The liquid reservoir 40 is divided into two portions, a first portion 44 and a second portion 46. The first portion 44 of the liquid reservoir 40 is located towards the mouth end of the outer housing 36, and comprises an annular space defined by the outer housing 36. The annular space has an internal passage 48 that extends between the mouth end opening 38, and the open end of the internal passage 26 of the susceptor holder 14. The second portion 46 of the liquid reservoir 40 is located towards the connection end of the outer housing 36, and comprises an annular space defined between an inner surface of the outer housing 36 and an outer surface of the susceptor holder 14. The base 20 of the tubular susceptor holder 14 is provided with an annular, ribbed, elastomeric seal 50 that extends between the outer surface of the tubular susceptor 14 and the internal surface of the outer housing 36. The seal 50 provides a liquid tight seal between the susceptor holder 14 and the outer housing 36, ensuring that the second portion 46 of the liquid reservoir 40 is capable of holding the liquid aerosol forming substrate 42.

The first and second portions 44, 46 of the liquid reservoir 40 are fluidly isolated from each other by an aluminium foil seal 52, which is pierceable by the piercing elements 34 of the susceptor holder to allow liquid aerosol-forming substrate 42 to flow between the first and second portions 44, 46 of the liquid reservoir, as described in more detail below.

An air passage is formed through the cartridge 10 by the internal passage 26 of the susceptor holder 14, and the internal passage 48 through the first portion 44 of the liquid reservoir 40. The air passage extends from the air inlets 32 in the base 30 of the susceptor holder 14, through the internal passage 26 of the susceptor holder 14, and through the internal passage 48 of the first portion 44 of the liquid reservoir 40 to the mouth end opening 38. The air passage enables air to be drawn through the cartridge 10 from the connection end to the mouth end.

In the storage configuration, as shown in FIGS. 1a and 1b, the base 30 of the susceptor holder 14 extends out of the outer housing 36, and the piercing elements 34 of the susceptor holder 14 are spaced from the seal 52 in the direction of the connection end of the cartridge 10. In this configuration, the liquid aerosol-forming substrate 42 is held in the first portion 44 of the liquid reservoir 40, and is isolated from the second portion 46 of the liquid reservoir 40 by the seal 52. Accordingly, in the storage configuration the susceptor assembly 12 is isolated from the aerosol-forming substrate 42. Advantageously, sealing the liquid aerosol-forming substrate 42 in the first portion 44 of the liquid reservoir 40 may entirely prevent the liquid aerosol-forming substrate 42 from leaking out of the cartridge 10 while the cartridge is in the storage configuration.

In the use configuration, as shown in FIG. 1c, the susceptor holder 14 and the susceptor assembly 12 are pushed into the outer housing 36, towards the mouth end. As the susceptor holder 14 is pushed towards the mouth end of the outer housing 36, the seal 50 at the base 30 of the susceptor holder 14 slides over the inner surface of the outer housing 36, maintaining a liquid tight seal between the inner surface of the outer housing 36 and the outer surface of the tubular susceptor holder body as the base of the susceptor holder 14 is received in the outer housing. As the piercing elements 34 of the susceptor holder 14 are moved towards the mouth end, the piercing elements 34 contact and pierce the seal 52, allowing fluid communication between the first portion 44 of the liquid reservoir 40, and the second portion 46 of the liquid reservoir 40. The liquid aerosol-forming substrate 42 in the first portion 44 of the liquid reservoir 40 is released into the second portion 46 of the liquid reservoir 40, and the susceptor assembly 12 is exposed to the liquid aerosol-forming substrate 42. In the use configuration, the mounting regions 22 of the first and second susceptor elements 16, 18, and the corresponding portions of the wicking element 20 that extend into the second portion 46 of the liquid reservoir 40, are able to draw the liquid aerosol-forming substrate 42 from the second portion 46 of the liquid reservoir 40 to the heating regions 24 of the first and second susceptor elements 16, 18. As a result, in the use configuration the cartridge 10 is ready for use to generate an aerosol by heating the aerosol-forming substrate 42.

FIGS. 6a and 6b show an aerosol-generating system comprising the cartridge 10 of FIGS. 1a, 1b, and 1c in the use configuration, received in an aerosol-generating device 60. The aerosol-generating system is portable and has a size comparable to a conventional cigar or cigarette.

The aerosol-generating device 60 comprises a generally cylindrical housing 62 having a connection end and a distal end opposite the connection end. A cavity 64 for receiving the connection end of the cartridge is located at the connection end of the device 60, and an air inlet 65 is provided through the outer housing 62 at the base of the cavity 64 to enable ambient air to be drawn into the cavity 64 at the base.

The device 60 further comprises an inductive heating arrangement arranged within the housing 62. The inductive heating arrangement includes a pair of inductor coils 66, 68, control circuitry 70 and a power supply 72. The power supply 72 comprises a rechargeable nickel cadmium battery, that is rechargeable via an electrical connector (not shown) at the distal end of the device. The control circuitry 70 is connected to the power supply 72, and to the first and second inductor coils 66, 68, such that the control circuitry 70 controls the supply of power to the inductor coils 66, 68. The control circuitry 70 is configured to supply an alternating current to the first and second inductor coils 66, 68.

The pair of inductor coils comprises a first inductor coil 66, and a second inductor coil 68. The first inductor coil 66 is arranged at a first side of the cavity 64, and the second inductor coil 68 is arranged at a second side of the cavity 64, opposite the first inductor coil 66. Each of the inductor coils 66, 68 is substantially identical, and comprises a planar coil having a rectangular cross-section, formed from rectangular cross-section wire. Each of the inductor coils 66, 68 extends substantially in a plane, with the first coil 66 extending in a first plane and the second coil 68 extending in a second plane. The first and second planes are substantially parallel to each other, and extend substantially parallel to a central longitudinal axis of the cavity 64 at the connection end of the device 60. When the cartridge 10 is received in the cavity 64, the susceptor assembly 12 is arranged between the first and second inductor coils 66, 68, and the plane of the susceptor assembly 12 is arranged substantially parallel to the first and second planes.

Each of the first and second inductor coils 66, 68 is configured such that when the alternating current is supplied to the inductor coils 66, 68, the inductor coil generates an alternating magnetic field in the cavity 64. The alternating magnetic field generated by each of the inductor coils 66, 68 is directed substantially perpendicular to the plane of the susceptor assembly 12, and the susceptor elements 16, 18.

The inductive heating arrangement is also configured such that the second inductor coil 68 generates an alternating magnetic field in the cavity 64 that is equal and opposite to the alternating magnetic field generated in the cavity 64 by the first inductor coil 66. In this embodiment, the first and second inductor coils 66, 68 are connected together in series, and are substantially identical, but are wound in opposite senses. In this configuration, the first and second inductor coils 66, 68 generate alternating magnetic fields in the cavity 64 with substantially equal magnitudes, but in substantially opposite directions.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10, as shown by the arrows in FIG. 6b. The ambient air flows through the cartridge 10 from the base 30 to the mouth end opening 38, through the air passage, and over the susceptor assembly 12.

The control circuitry 70 controls the supply of electrical power from the power supply 72 to the first and second inductor coils 66, 68 when the system is activated. The control circuitry 72 may include an airflow sensor (not shown), and the control circuitry 72 may supply electrical power to the inductor coils 66, 68 when user puffs on the cartridge 10 are detected by the airflow sensor. This type of control arrangement is well established in aerosol-generating systems such as inhalers and e-cigarettes.

When the system is activated, an alternating current is established in each of the inductor coils 66, 68, which generates an alternating magnetic field in the cavity 64 that penetrates the susceptor assembly 12, causing the heating regions 24 of the first and second susceptor elements 16, 18 to heat. Liquid aerosol-forming substrate in the second portion 44 of the liquid reservoir 40 is drawn into the susceptor assembly 12 through the wicking element 20 to the heating regions 24 of the first and second susceptor elements 16, 18. The liquid aerosol-forming substrate at the heating regions 24 of the susceptor elements 16, 18 is heated, and volatile compounds from the heated aerosol-forming substrate are released into the air passage of the cartridge 10, which cool to form an aerosol. The aerosol is entrained in the air being drawn through the air passage of the cartridge 10, and is drawn out of the cartridge 10 at the mouth end opening 38 for inhalation by the user.

FIGS. 7 to 9 show methods for manufacturing a susceptor element 16 as shown in FIGS. 3 to 5.

Method 700 comprising providing 710, a magnetic material and a non-magnetic material. The non-magnetic material may comprise an electrically insulating material. The non-magnetic material may comprise a thermally insulating material.

Method 700 further comprises bonding 720, the magnetic material to the non-magnetic material in order to form a susceptor sheet comprising a heating region 24 for heating an aerosol-forming substrate and a mounting region 22 for securing the susceptor element 16 to a susceptor holder 14. The heating region 24 comprises the magnetic material and the mounting region 22 comprises the non-magnetic material. The bonding may comprise any one of adhesion, thermocompression, brazing, welding, compression, chemical deposition or vapor deposition, and may be performed using any of the means known in the art. In an embodiment, method 700 comprises bonding a second non-magnetic material to the magnetic material in order to form a second mounting region 22 on an opposite side of the magnetic material to the first mounting region 22, as illustrated in FIG. 3. In some embodiments, the method 700 comprises cutting the bonded susceptor sheet to form a plurality of susceptor elements 16, each comprising a heating region 24 and a mounting region 22. In some embodiments, method 700 further comprises perforating the heating region 24 of the susceptor 16. In some embodiments, method 700 further comprises perforating the mounting region 22 of the susceptor 16.

FIGS. 8 and 9 show methods 800, 900 for efficiently manufacturing a plurality of susceptor elements 16 according to those illustrated in FIGS. 5 and 4 respectively.

Method 800 comprises providing 810, a first plurality of strips of magnetic material at spaced intervals across the width of a first face of a strip of non-magnetic material. Next, at step 820, a second plurality of strips of magnetic material are provided at spaced intervals across the width of a second face of the strip of non-magnetic material aligned with the first plurality of strips. The first and second plurality of strips of magnetic material have a length equal to the width of the strip of non-magnetic material.

Step 830 comprises compressing the first plurality of strips of magnetic material and second plurality of strips of magnetic material into the strip of non-magnetic material to form a susceptor sheet. The compressing may be carried out using any suitable method known in the art. For example, in some embodiments a roller, or a pair of rollers may be used to compress the magnetic material into the non-magnetic material to form a single susceptor sheet.

Step 840 comprises cutting the susceptor sheet widthways to form a plurality of susceptor elements 16, each susceptor element 16 having a heating region 24 between two opposing mounting regions 22, such as that illustrated in FIG. 5. In some embodiments, method 800 further comprises perforating the heating region 24 of the susceptor 16. In some embodiments, method 800 further comprises perforating the mounting region 22 of the susceptor 16.

Method 900 comprises providing, at step 910, a strip of magnetic material. At step 920, one or more layers of non-magnetic material are applied around edges of both faces of the strip of magnetic material in order to form a susceptor sheet consisting of a strip of magnetic material having a non-magnetic boarder. The one or more layers of non-magnetic material may be applied to the strip of magnetic material using any of the bonding mechanisms described above in relation to method 700.

Step 930 comprises cutting the susceptor sheet widthways to form a plurality of susceptor elements, each susceptor element 16 having a heating region 24 separating two opposing mounting regions 22, such as that illustrated in FIG. 4. In some embodiments, method 900 further comprises perforating the heating region 24 of the susceptor 16. In some embodiments, method 900 further comprises perforating the mounting region 22 of the susceptor 16.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10 percent (10 %) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method for manufacturing a susceptor element for an aerosol-generating system, the method comprising:
bonding a magnetic material to a non-magnetic material to form a susceptor sheet comprising:
a heating region configured to heat an aerosol-forming substrate, and
a mounting region configured to secure the susceptor element to a susceptor holder,
wherein the heating region comprises magnetic material and the mounting region comprises non-magnetic material, and
wherein the mounting region comprises a lower proportion by weight of magnetic material compared to the heating region.

17. The method according to claim 16, wherein the non-magnetic material comprises an electrically insulating material.

18. The method according to claim 16, wherein the non-magnetic material comprises a thermally insulating material.

19. The method according to claim 16, wherein the bonding comprises compression.

20. The method according to claim 16, further comprising:
bonding a first plurality of strips of magnetic material at spaced intervals across a strip of non-magnetic material; and
cutting the susceptor sheet to form a plurality of susceptor elements.

21. The method according to claim 20, further comprising:
providing the plurality of strips of magnetic material at spaced intervals across the width of the strip of non-magnetic material; and
compressing the strips of magnetic material into the strip of non-magnetic material to form the susceptor sheet.

22. The method according to claim 21, further comprising compressing the strips of magnetic material into the strip of non-magnetic material using one or more rollers.

23. The method according to claim 20, further comprising:
bonding a second plurality of strips of magnetic material at spaced intervals across the strip of non-magnetic material opposite the first plurality of magnetic strips, wherein the first plurality of strips substantially align with the second plurality of strips; and
cutting the susceptor sheet widthways to form a plurality of susceptor elements, each susceptor element having a heating region separating two opposing mounting regions.

24. The method according to claim 16, wherein the bonding comprises depositing the non-magnetic material on a surface of a sheet of magnetic material at a mounting region.

25. The method according to claim 16,
further comprising:
bonding a first plurality of strips of non-magnetic material at spaced intervals at an edge region along a length of a strip of magnetic material; and
cutting the susceptor sheet widthways into a plurality of susceptor elements,
wherein the bonding comprises depositing the non-magnetic material on a surface of a sheet of magnetic material at a mounting region.

26. The method according to claim 25,
further comprising bonding a second plurality of strips of non-magnetic material at spaced intervals at an opposing edge region along the length of the strip of magnetic material,
wherein the first plurality of strips substantially align with the second plurality of strips.

27. The method according to claim 16, further comprising perforating the heating region of the susceptor element.

28. A susceptor element manufactured using a method according to claim 16.

29. A cartridge for an aerosol-generating system, comprising a susceptor holder mounting a susceptor element according to claim 28 across an air channel.

30. An aerosol-generating system comprising the cartridge according to claim 29.
